(19) United States
(12) Patent Application Publication
(10) Pub. No.: US 2021/0117017 A1
(43) Pub. Date: Apr. 22, 2021

(54) STYLUS STRUCTURE

(71) Applicant: Waltop International Corporation, HSINCHU CITY (TW)

(72) Inventors: YI-CHIH CHANG, Hsinchu City (TW); CHUNG-FUU MAO, NEW TAIPEI CITY (TW)

(21) Appl. No.: 16/796,251

(22) Filed: Feb. 20, 2020

(30) Foreign Application Priority Data
Oct. 17, 2019 (TW) 108137497

(51) Int. Cl. G06F 3/0354; G06F 3/039

(52) U.S. Cl. CPC G06F 3/03545; G06F 3/039

(57) ABSTRACT

A stylus structure including a stylus housing unit, a magnetic attaching unit, and a cover unit is provided. The stylus housing unit includes a stylus body component and a touch control component disposed at an end of the stylus body component. A first magnetic member is disposed at another end of the stylus body component. The magnetic attaching unit is sleeved at another end of the stylus body component. The cover unit includes a cover body component and a supportive component, and a second magnetic member is disposed on the supportive component. The cover body component is detachably sleeved at another end of the stylus body component and magnetically attached to the magnetic attaching unit, and the second magnetic member and the first magnetic member are magnetically attached to each other.

CROSS-REFERENCE TO RELATED PATENT APPLICATION This application claims the benefit of priority to Taiwan Patent Application No. 108137497, filed on Oct. 17, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a stylus structure, and more particularly to a stylus structure with a cover being magnetically attached.

### BACKGROUND OF THE DISCLOSURE

There are many methods to operate a touch panel, the most common one being to touch or slide a finger or a stylus on a surface of the touch panel so that a sensor inside the touch panel generates corresponding signals.

In the related art, in a conventional capacitive stylus with a cover, the cover is commonly fixed to the stylus by snap-fitting. Therefore, after being used for a long time, the snap-fitting structure may wear out, and as a result, the cover may fall of easily and a user may be prone to lose the cover.

### SUMMARY OF THE DISCLOSURE

In response to the above-referenced technical inadequacies, the present disclosure provides a stylus structure.

In one aspect, the present disclosure provides a stylus structure including a stylus housing unit, a magnetic attaching unit, and a cover unit. The stylus housing unit includes a stylus body component and a touch control component that is disposed at an end of the stylus body component. A first magnetic member is disposed at another end of the stylus body component. The magnetic attaching unit is sleeved at another end of the stylus body component. The cover unit includes a cover body component and a supportive component that is connected to the cover body component, and a second magnetic member is disposed on the supportive component. The cover body component is detachably sleeved at another end of the stylus body component and magnetically attached to the magnetic attaching unit, and the second magnetic member and the first magnetic member are magnetically attached to each other.

In another aspect, the present disclosure provides a stylus structure including a stylus housing unit, a magnetic attaching unit, and a cover unit. The stylus housing unit includes a first magnetic member. The magnetic attaching unit is sleeved on the stylus housing unit. The cover unit includes a second magnetic member. The cover unit is detachably sleeved on the stylus housing unit and magnetically attached to the magnetic attaching unit, and the second magnetic member and the first magnetic member are magnetically attached to each other.

Therefore, one beneficial effect of the present disclosure is that the stylus structure provided in the present disclosure can improve on the stability of attachment between the cover unit and the stylus housing unit through the foregoing aspects.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a perspective view of a stylus structure according to a first embodiment of the present disclosure.

FIG. 2 is a partial exploded view of the stylus structure according to the first embodiment of the present disclosure.

FIG. 3 is a partial sectional view of the stylus structure according to the first embodiment of the present disclosure.

FIG. 4 is a first magnified view of the partial section of FIG. 3.

FIG. 5 is a schematic view of the stylus structure in operation according to the first embodiment of the present disclosure which corresponds to the partial cross section of FIG. 3.

FIG. 6 is a partial exploded view of a stylus structure according to a second embodiment of the present disclosure.

FIG. 7 is an exploded view of a stylus structure according to a third embodiment of the present disclosure.

FIG. 8 is a partial sectional view of the stylus structure according to a third embodiment of the present disclosure which corresponds to the partial cross section of FIG. 3.

FIG. 9 is a schematic view of the stylus structure in operation according to the third embodiment of the present disclosure.

FIG. 10 is a partial exploded view of a stylus structure according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

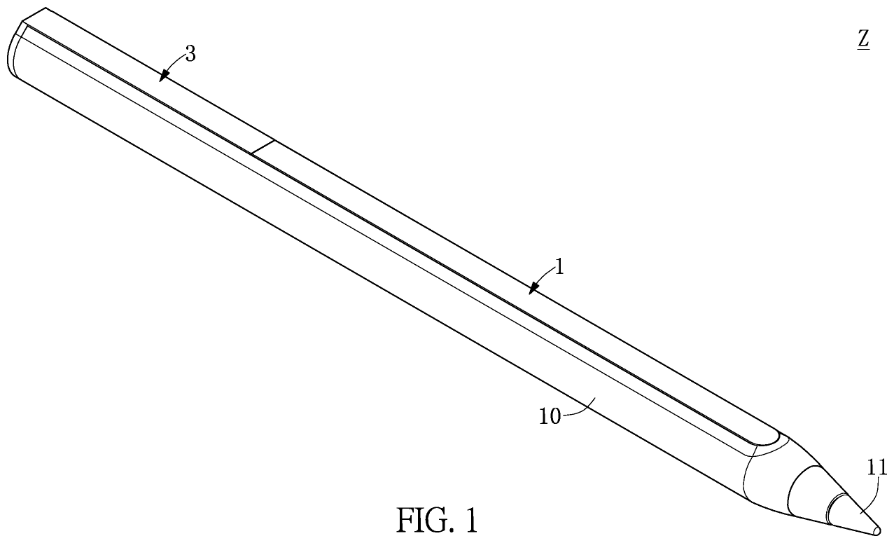

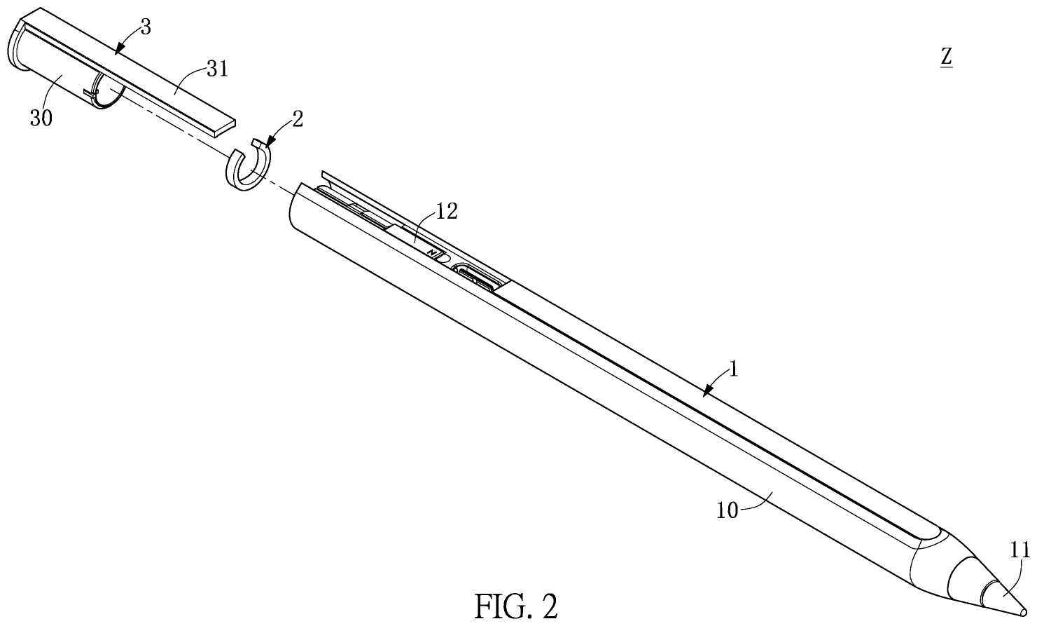

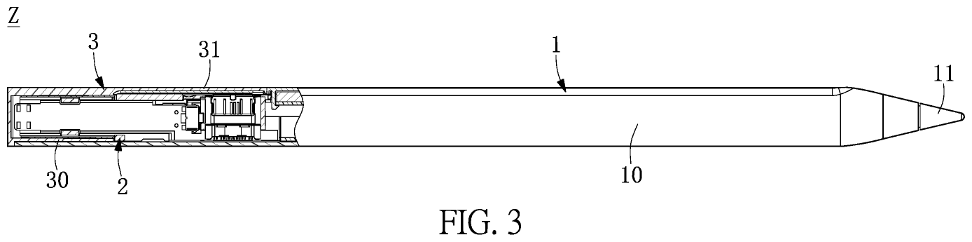

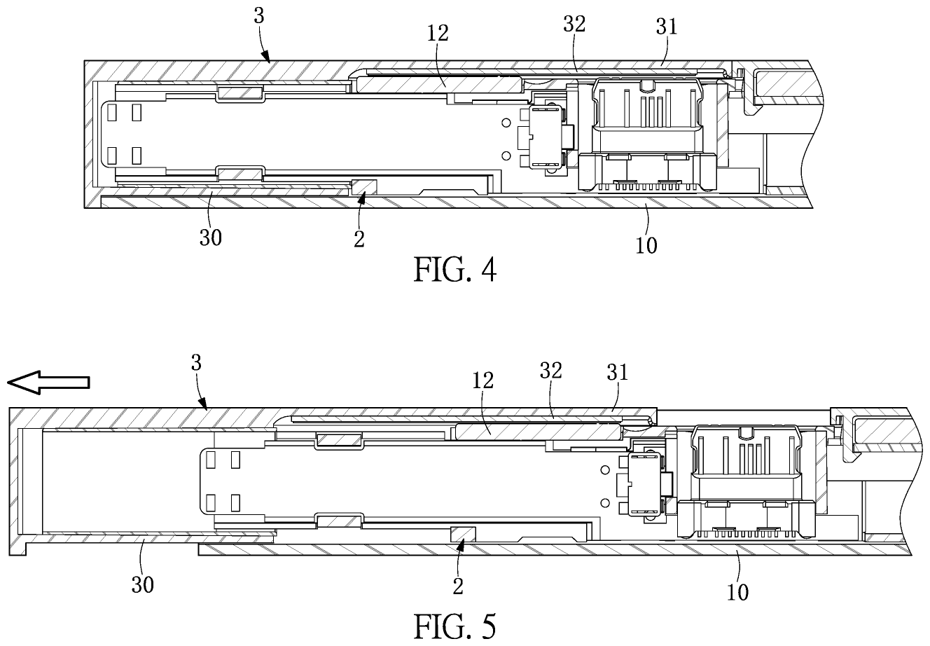

Reference is made to FIG. 1 to FIG. 5. FIG. 1, FIG. 2, and FIG. 3 are a perspective view, a partial exploded view, and a partial sectional view of a stylus structure according to a first embodiment of the present disclosure. FIG. 4 is a first magnified view of the partial cross section of FIG. 3. FIG. 5 is a schematic view of the stylus structure in operation according to the first embodiment of the present disclosure. The first embodiment of the present disclosure provides a stylus structure Z including a stylus housing unit 1, a magnetic attaching unit 2 and a cover unit 3. The stylus housing unit 1 includes a stylus body component 10 and a touch control component 11 that is disposed at an end of the stylus body component 10. A first magnetic member 12 is disposed at another end of the stylus body component 10. The magnetic attaching unit 2 is sleeved at another end of the stylus body component 10. The cover unit 3 includes a cover body component 30 and a supportive component 31 that is connected to the cover body component 30, and a second magnetic member 32 is disposed on the supportive component 31. The cover body component 30 is detachably sleeved at another end of the stylus body component 10 and attached to the magnetic attaching unit 2, and the first magnetic member 12 and the second magnetic member 32 are attached to each other.

Specifically, the first embodiment of the present disclosure provides a stylus structure Z including a stylus housing unit 1, a magnetic attaching unit 2, and a cover unit 3. The stylus housing unit 1 includes a stylus body component 10 and a touch control component 11. The touch control component 11 can be used for a touch tablet or a touch screen, but is not limited thereto. The first magnetic member 12 can be disposed at another end of the stylus body component 10. The first magnetic member 12 can be a magnet and have an elongated structure, but is not limited thereto. The magnetic attaching unit 2 can be a magnet and can have a C-shaped structure or ring structure. When the magnetic attaching unit 2 has the C-shaped structure, a notch of the magnetic attaching unit 2 corresponds to the first magnetic member 12. The cover unit 3 includes a cover body component 30 and the supportive component 31, and the cover body component 30 is detachably sleeved at another end of the stylus body component 10. The second magnetic member 32 can be a magnet and have an elongated structure but not limited thereto.

Therefore, when the cover unit 3 and the stylus body component 10 are connected together, the magnetic attaching unit 2 at another end of the stylus body component 10 can attract the cover body component 30, and the second magnetic member 32 and the first magnetic member 12 can magnetically attach to each other, so that the cover body component 30 can firmly attach to the stylus body component 10. On the other hand, when a user detaches the cover body component 30 from the stylus body component 10, during the process of gradually separating the cover body component 30 from the stylus body component 10, the first magnetic member 12 and the second magnetic member 32 can magnetically attach to each other so as to achieve the position limiting effect and the position fixing effect. Therefore, the cover body component 30 is limited to a current position to prevent the cover body component 30 from being attracted to the magnetic attaching unit 2 and covering onto the stylus body component 10 again.

### Second Embodiment

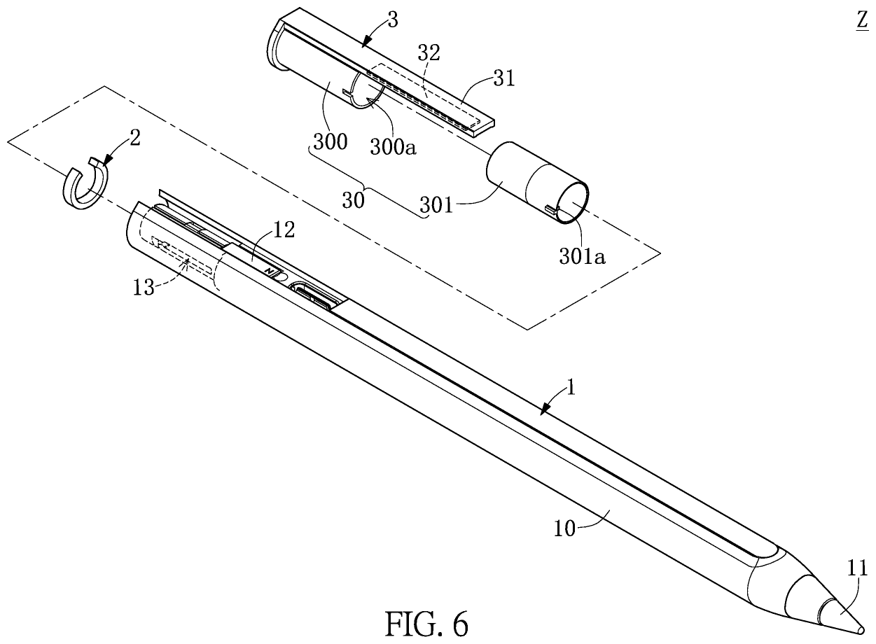

Reference is made to FIG. 6, which is a partial exploded view of a stylus structure of a second embodiment of the present disclosure, and is to be read in conjunction with FIG. 1 to FIG. 5. In the stylus structure Z of the present embodiment, the working principles of the same components and those of the stylus structure Z of the first embodiment are similar, and descriptions thereof will be omitted herein. It should be noted that, in the present embodiment, the cover body component 30 includes a housing member 300 connected to the supportive component 31 and a fixation member 301. The housing member 300 has a recess 300a, and the fixation member 301 is detachably disposed in the recess 300a. When the housing member 300 and the fixation 301 are sleeved at another end of the stylus body component 10, the fixation member 301 is attached to the magnetic attaching unit 2. In addition, the supportive component 31 and the housing member 300 are integrally formed as a one piece structure.

For instance, the cover body component 30 further includes a housing member 300 and the fixation member 301, in which the supportive component 31 can be formed by housing member 300 extending outward, but the present disclosure is not limited thereto. The fixation member 301 is detachably disposed in the recess 300a, and the fixation member 301 can be made by metal or magnetic materials.

Therefore, when the user covers the stylus body component 10 with the cover body component 30, the fixation member 301 is attached to the magnetic attaching unit, so that the cover body component 30 can firmly cover the stylus body component 10.

In addition, a guide track 13 can be formed at another end of the stylus body component 10, and a position limiting part 301a is formed on the fixation member 301. The position limiting part 301a is slidably disposed in the guide track 13, and the guide track is L-shaped. For instance, referring to FIG. 6, in the present disclosure, the structures of the guide track 13 and the position limiting part 301a are designed in a way so that, when the cover body component 30 is detached from or covers the stylus body component 10, the first magnetic member 12 and the second magnetic member 32 can firmly and parallelly correspond to each other, thereby preventing a problem of misalignment.

### Third Embodiment

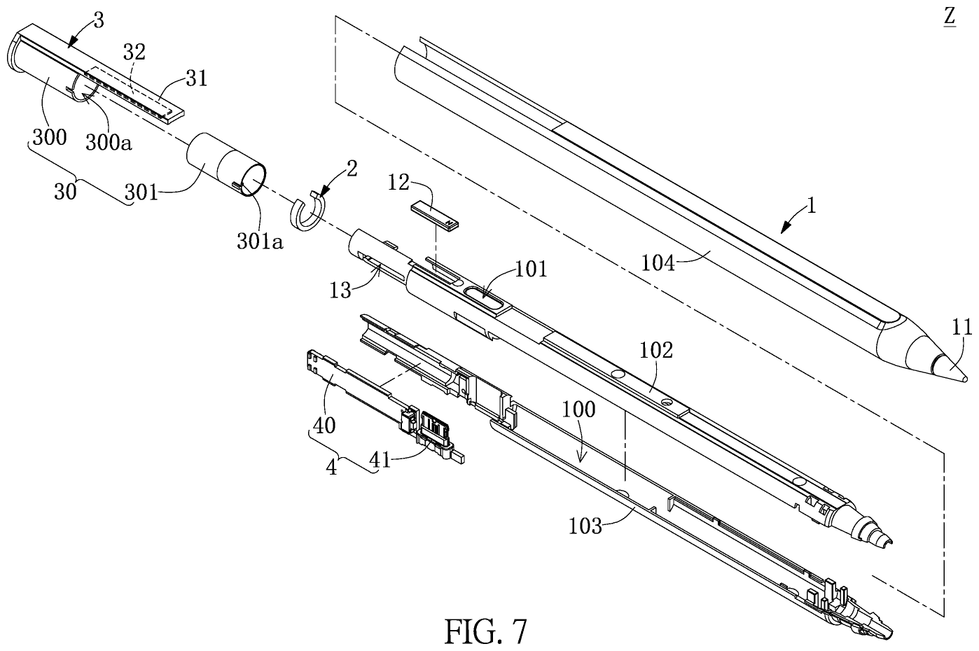

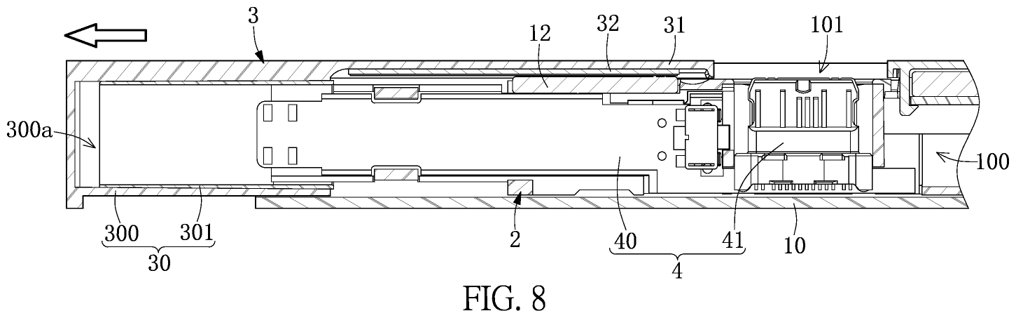

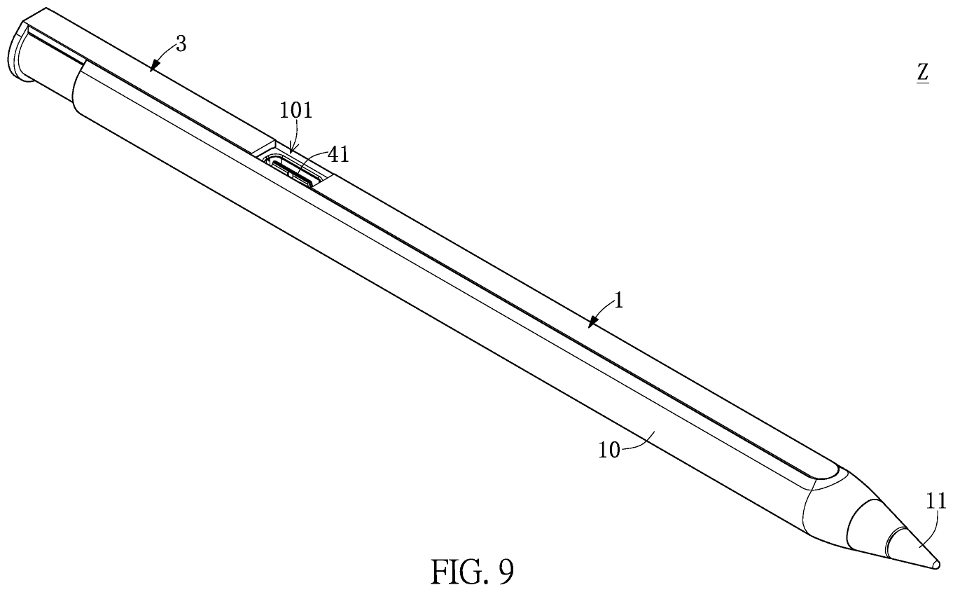

Reference is made to FIG. 7, FIG. 8, and FIG. 9, which are a partial exploded view, an exploded view, and a partial sectional view of a stylus structure according to a third embodiment of the present disclosure, and are to be read in conjunction with FIG. 1 to FIG. 6. In the stylus structure Z of the present embodiment, the working principles of the same components and those of the stylus structure Z of the above-mentioned embodiments are similar, and descriptions thereof will be omitted herein. It should be noted that, in the present embodiment, the stylus body component 10 includes an accommodating space 100 and an opening 101 being in spatial communication with the accommodating space 100. In addition, the stylus structure Z further includes a control unit 4 including a processing component 40 located in the accommodating space 100 and a transmission component 41 corresponding to the opening 101. The transmission component 41 is electrically connected to the processing component 40. The cover body component 30 is sleeved at another end of the stylus body component 10, so that the supportive component 31 can cover the opening 101.

Specifically, the processing component 40 can be a circuit board with a processor, and the processing component 40 can be located in the accommodating space 100. The transmission component 41 can be a component with a function of transmitting electrical power or signals. The transmission 41 can be electrically connected to the processing component 40, and corresponds to the opening 101.

Therefore, when the user wishes to transmit electrical power or signals, the cover body component 30 can be partially or completely detached from the stylus body component 10 to expose the opening 101. Thereafter, an external transmission wire can be used to connect the transmission component 41 to transmit electrical power or signals to the processing component 40. On the other hand, when not transmitting electrical power or signals, the user can cover the stylus body component 10 with the cover body component 30, so that the supportive component 31 can cover the opening 101 and the transmission component 41.

Furthermore, the stylus body component 10 can include a first case member 102, a second case member 103, and a sleeve member 104. The first case member 102 is detachably connected to the second case member 103. The sleeve member 104 is detachably sleeved on the first case member 102 and the second case member 103. The accommodating space 100 is formed between the first case member 102 and the second case member 103. For instance, referring to FIG. 7, after the first case member 102 and the second case member 103 are connected together, the sleeve member 104 can be sleeved outside the first case member 102 and the second case member 103 to form the stylus body component 10.

### Fourth Embodiment

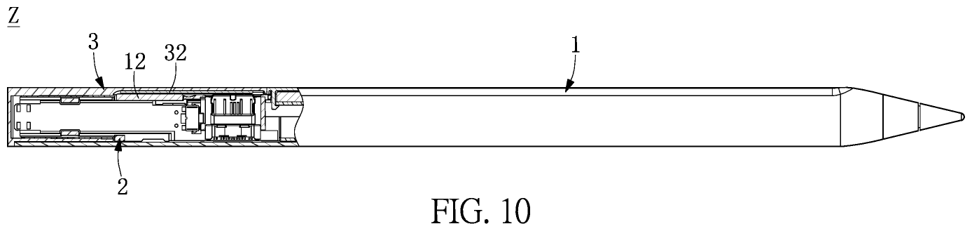

Reference is made to FIG. 10, which is a partial exploded view of a stylus structure according to a fourth embodiment of the present disclosure, and is to be read in conjunction with FIG. 1 to FIG. 9. The present embodiment provides a stylus structure Z including a stylus housing unit 1, a magnetic attaching unit 2, and a cover unit 3. A first magnetic member 12 is disposed on the stylus housing unit 1. The magnetic attaching unit 2 is detachably sleeved on the stylus housing unit 1. A second magnetic member 32 is disposed on the cover unit 3, and the cover unit 3 is detachably sleeved on the stylus housing unit 1 and attached to the magnetic attaching unit 2. The second magnetic member 32 and the first magnetic member 12 are attached to each other.

Specifically, the present embodiment provides the stylus structure Z including a stylus housing unit 1, a magnetic attaching unit 2, and a cover unit 3. The first magnetic member 12 is disposed on the stylus housing unit 1. In which, the first magnetic member 12 can be a magnet and can be in an elongated shape, but the present disclosure is not limited thereto. The magnetic attaching unit 2 can be a magnet and can have a C-shaped structure or ring structure. When the magnetic attaching unit 2 has the C-shaped structure, a notch of the magnetic attaching unit 2 corresponds to the first magnetic member 12. The cover unit 3 includes a second magnetic member 32. The second magnetic member 32 can be a magnet and can have an elongated structure, but the present disclosure is not limited thereto.

Therefore, when the cover unit 3 and the stylus housing unit 1 are connected together, the magnetic attaching unit 2 on the stylus housing unit 1 can attract the cover unit 3, and the second magnetic member 32 and the first magnetic member 12 can magnetically attach to each other, so that the cover unit 3 can firmly attach to the stylus housing unit 1. On the other hand, when a user detaches the cover unit 3 from the stylus housing unit 1, during the process of gradually separating the cover unit 3 from the stylus housing unit 1, the first magnetic member 12 and the second magnetic member 32 can attach to each other so as to achieve the position limiting effect and the position fixing effect. Therefore, the cover unit 3 is limited to a current position to prevent the cover unit 3 from being attracted to the magnetic attaching unit 2 and covering onto the stylus housing unit 1 again.

In addition, the cover unit 3 can include a housing member 300 and a fixation member 301. The housing member 300 has a recess 300a, and the fixation member 301 is detachably disposed in the recess 300a. The implementations disclosed in the present embodiment and those in the above-mentioned second embodiment are similar, and descriptions thereof will be omitted herein.

Moreover, the stylus housing unit 1 can have a guide track 13, and the fixation member 301 can have a position limiting part 301a. The position limiting part 301 is slidably disposed in the guide track 13. The implementations disclosed in the present embodiment and those in the above-mentioned second embodiment are similar, and descriptions thereof will be omitted herein.

Further, the stylus housing unit 1 can have an accommodating space 100 and an opening 101 being in spatial communication with the accommodating space 100. In addition, the stylus structure Z further includes a control unit 4 including a processing component 40 located in the accommodating space 100 and a transmission component 41 corresponding to the opening 101. The implementations disclosed in the present embodiment and those in the above-mentioned third embodiment are similar, and descriptions thereof will be omitted herein.

Furthermore, the stylus housing unit 1 can include a first case member 102, a second case member 103, and a sleeve member 104. The implementations disclosed in the present embodiment and those in the above-mentioned third embodiment are similar, and descriptions thereof will be omitted herein.

However, the above-mentioned embodiments are only certain practicable embodiments, and are not intended to limit the present disclosure.

### Beneficial Effects of Embodiments

In conclusion, one of the beneficial effects of the present disclosure is that the stylus structure provided in the present disclosure can improve the stability of attachment between the cover unit and the stylus housing unit through the aspects of “the stylus housing unit 1 includes a stylus body component 10 and a touch control component 11 that is disposed at an end of the stylus body component 10, and a first magnetic member 12 is disposed at another end of the stylus body component 10”, “the magnetic attaching unit 2 is sleeved at another end of the stylus body component 10”, and “the cover unit 3 includes a cover body component 30 and a supportive component 31 connected to the cover body component 30, a second magnetic member 32 is disposed on the supportive component 31, the cover body component 30 is detachably sleeved at another end of the stylus body component 10 and magnetically attached to the magnetic attaching unit 2, and the first magnetic member 12 and the second magnetic member 32 are magnetically attached to each other”.

Another one of the beneficial effects of the present disclosure is that the stylus structure provided in the present disclosure can improve the stability of attachment between the cover unit and the stylus housing unit through the aspects of “a first magnetic member 12 is disposed on the stylus housing unit 1”, “the magnetic attaching unit 2 is sleeved on the stylus housing unit 1” and “a second magnetic member 32 is disposed on the cover unit 3, the cover unit 3 is detachably sleeved on the stylus housing unit 1 and magnetically attached to the magnetic attaching unit 2, and the second magnetic member 32 and the first magnetic member 12 are magnetically attached to each other”.

Furthermore, through the foregoing aspects, in the stylus structure Z provided in the present disclosure, the structures of the stylus housing unit 1, the magnetic attaching unit 2, and the cover unit 3 are designed in a way so that, when the cover unit 3 is connected to the stylus body component 10, the cover body component 30 can firmly attach to the stylus body component 10. On the other hand, when a user detaches the cover unit 3 from the stylus body component 10, the first magnetic member 12 and the second magnetic member 32 can attach to each other so as to achieve the position limiting effect and the position fixing effect. Therefore, the cover body component 30 can be prevented from being attracted to the magnetic attaching unit 2 and covering onto the stylus body component 10 again. In addition, the structures of the guide track 13 and the position limiting part 301a are designed in a way so that, when the cover body component 30 is detached from or covers the stylus body component 10, the first magnetic member 12 and the second magnetic member 32 can firmly and parallelly correspond to each other, thereby preventing a problem of misalignment.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

1. A stylus structure, comprising:
a stylus housing unit including a stylus body component and a touch control component that is disposed at an end of the stylus body component, wherein a first magnetic member is disposed at another end of the stylus body component;
a magnetic attaching unit sleeved and fixed at the another end of the stylus body component; and
a cover unit including a cover body component and a supportive component that is connected to the cover body component, wherein a second magnetic member is disposed on the supportive component, the cover body component is detachably sleeved at the another end of the stylus body component and is magnetically attached to the magnetic attaching unit, and the second magnetic member and the first magnetic member are magnetically attached to each other;
wherein the cover body component includes a housing member connected to the supportive component and a fixation member, a recess is formed in the housing member, the fixation member is detachably disposed in the recess; when the housing member and the fixation member are sleeved at the another end of the stylus body component, the fixation member is magnetically attached to the magnetic attaching unit and wherein the supportive component and the housing member are integrally formed, and
the second magnetic member and the first magnetic member are still magnetically attached to each other as the cover component is gradually separated from the stylus body component when the cover body component is detached from the stylus body component.

2. The stylus structure according to claim 1, wherein the supportive component and the housing member are integrally formed.

3. The stylus structure according to claim 2, wherein a guide track is formed at the another end of the stylus body component, a position limiting part is located on the fixation member, and the position limiting part is slidably disposed in the guide track, and wherein the guide track is L-shaped.

4. The stylus structure according to claim 1, wherein the stylus body component has an accommodating space and an opening being in spatial communication with the accommodating space, wherein the stylus structure further includes a control unit including a processing component located in the accommodating space and a transmission component corresponding to the opening, the transmission component is electrically connected to the processing component, and wherein the cover body component is sleeved at the another end of the stylus body component so that the supportive component covers the opening.

5. The stylus structure according to claim 4, wherein the stylus body component includes a first case member, a second case member, and a sleeve member, wherein the first case member is detachably connected to the second case member, the sleeve member is detachably sleeved on the first case member and the second case member, and the accommodating space is formed between the first case member and the second case member.

6. A stylus structure, comprising:
a stylus housing unit including a first magnetic member;
a magnetic attaching unit sleeved and fixed on the stylus housing unit; and
a cover unit including a second magnetic member, wherein the cover unit is detachably sleeved on the stylus housing unit and magnetically attached to the magnetic attaching unit, and the second magnetic member and the first magnetic member are magnetically attached to each other;
wherein the cover body component includes a housing member connected to the supportive component and a fixation member, a recess is formed in the housing member, the fixation member is detachably disposed in the recess; when the housing member and the fixation member are sleeved at the another end of the stylus body component, the fixation member is magnetically attached to the magnetic attaching unit and wherein the supportive component and the housing member are integrally formed, and
the second magnetic member and the first magnetic member are still magnetically attached to each other as the cover component is gradually separated from the stylus body component when the cover body component is detached from the stylus body component.

7. (canceled)

8. The stylus structure according to claim 6, wherein a guide track is formed at another end of the stylus body component, a position limiting part is located on the fixation member, and the position limiting part is slidably disposed in the guide track, and wherein the guide track is L-shaped.

9. The stylus structure according to claim 6, wherein the stylus body component has an accommodating space and an opening being in spatial communication with the accommodating space, wherein the stylus structure further includes a control unit including a processing component located in the accommodating space and a transmission component corresponding to the opening, and the transmission component is electrically connected to the processing component, and wherein the cover unit is sleeved on the stylus body component to cover the opening.

10. The stylus structure according to claim 9, wherein the stylus housing unit includes a first case member, a second case member, and a sleeve member, wherein the first case member is detachably connected to the second case member, the sleeve member is detachably sleeved on the first case member and the second case member, and the accommodating space is formed between the first case member and the second case member.
